(19) United States
(12) Patent Application Publication
(10) Pub. No.: US 2011/0098974 A1
(43) Pub. Date: Apr. 28, 2011

(54) ADAPTIVE DIFFERENTIAL RATIO-METRIC DETECTOR

(76) Inventor: Shou-Hua Zhang, Arcadia (CA)

(21) Appl. No.: 12/919,945

(22) PCT Filed: Feb. 25, 2009
(86) PCT No.: PCT/US2009/035068

§ 371 Date: Dec. 3, 2010

Related U.S. Application Data
(60) Provisional application No. 61/064,352, filed on Feb. 29, 2008.

(51) Int. Cl. G06F 19/00

(52) U.S. Cl. 702/181

(57) ABSTRACT

A method and system for detecting and classifying sensor data, includes obtaining at least one feature vector from a sample to be analyzed, the sample to be analyzed being applied to an array of sensors that includes at least two differential sensors. The method and system also includes converting the at least one feature vector to at least one ratio-metric feature vector. The method and system further includes comparing the at least one ratio-metric feature vector to a detection threshold, and outputting an alarm to denote that the sample is abnormal when the detection threshold is exceeded. When the at least one ratio-metric feature vector does not exceed the detection threshold, the method and system includes classifying the sample as normal and feeding back the at least one ratio-metric feature vector to recompute the detection threshold for future samples to be detected and classified.

This application claims benefit to U.S. provisional patent application No. 61/064,352, filed Feb. 29, 2008 to Shou-Hua ZHANG, which is hereby incorporated by reference in its entirety.

### FIELD OF THE INVENTION

This invention is related in general to the field of sensor array detection and classification.

### BACKGROUND OF THE INVENTION

Sensor array units having sensor arrays are becoming very useful in today's society, with the threat of chemi- and bio-terrorism being more and more prominent. In more detail, chemical and biological warfare pose both physical and psychological threats to military and civilian forces, as well as to civilian populations.

An important feature of a sensor array unit is the ability to detect abnormalities in a sample, and to output an alarm when the abnormality is detected. Given that an abnormality may occur when only a very small concentration of a particular analyte exists in a sample, it is important that the sensor array unit is highly sensitive to such a very small concentration of the particular analyte.

### SUMMARY OF THE INVENTION

The present invention relates to a method and apparatus for sensor array detection and classification.

In accordance with one aspect of the invention, there is provided a method for detecting and classifying sensor data. The method includes obtaining at least one feature vector from a sample to be analyzed, the sample to be analyzed being applied to an array of sensors that includes at least two differential sensors. The method also includes converting the at least one feature vector to at least one ratio-metric feature vector. The method further includes comparing the at least one ratio-metric feature vector to a detection threshold, and outputting an alarm to denote that the sample is abnormal when the detection threshold is exceeded. The method still further includes, when the at least one ratio-metric feature vector does not exceed the detection threshold, classifying the sample as normal, performing a run adaptive moving average using the at least one feature vector and prior feature vectors obtained from normal samples, estimating parameters of probability distribution using the prior feature vectors obtained from normal samples, and recomputing the detection threshold based on the parameters of probability distribution, to be used to detect a future sample to be analyzed.

In accordance with another aspect of the invention, there is provided a system for detecting and classifying sensor data. The system includes an array of sensors that includes at least two differential sensors that are provided on or near a sample to be analyzed. The system further includes a feature vector extracting unit configured to obtain at least one feature vector from the sample to be analyzed. The system also includes a converting unit configured to convert the at least one feature vector to at least one ratio-metric feature vector. The system further includes a comparing unit configured to compare the at least one ratio-metric feature vector to a detection threshold, and to output an alarm to denote that the sample is abnormal when the detection threshold is exceeded. The system still further includes a classifying unit configured to classify the sample as normal when the detection threshold is not exceeded, a run adaptive moving average unit configured to compute a run adaptive moving average using the at least one feature vector and prior feature vectors obtained from normal samples, a parameter estimating unit configured to estimate parameters of probability distribution using the prior feature vectors obtained from normal samples, and a detection threshold recomputing unit configured to recompute the detection threshold based on the parameters of probability distribution, to be used to detect a future sample to be analyzed.

In accordance with yet another aspect of the invention, there is provided a computer readable medium embodying computer program product for detecting and classifying sensor data, the computer program product, when executed by a computer or a microprocessor, causing the computer or the microprocessor to perform the steps of:
obtaining at least one feature vector from a sample to be analyzed, the sample to be analyzed being applied to an array of sensors that includes at least two differential sensors;
converting the at least one feature vector to at least one ratio-metric feature vector;
comparing the at least one ratio-metric feature vector to a detection threshold;
when the detection threshold is exceeded, outputting an alarm to denote that the sample is abnormal;
when the at least one ratio-metric feature vector does not exceed the detection threshold,
   classifying the sample as normal,
   performing a run adaptive moving average using the at least one feature vector and prior feature vectors obtained from normal samples,
   estimating parameters of probability distribution using the prior feature vectors obtained from normal samples, and
   recomputing the detection threshold based on the parameters of probability distribution, to be used to detect a future sample to be analyzed.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a flow diagram diagramming a method of performing sensor array detection and classification, according to a first embodiment.

FIG. 2 is a block diagram of a sensor array detection and classification, according to a second embodiment.

### DETAILED DESCRIPTION

Reference will now be made in detail to embodiments of the invention, examples of which are illustrated in the accompanying drawings. An effort has been made to use the same reference numbers throughout the drawings to refer to the same or like parts.

Unless explicitly stated otherwise, “and” can mean “or,” and “or” can mean “and.” For example, if a feature is described as having A, B, or C, the feature can have A, B, and C, or any combination of A, B, and C. Similarly, if a feature is described as having A, B, and C, the feature can have only one or two of A, B, or C.

Unless explicitly stated otherwise, “a” and “an” can mean “one or more than one.” For example, if a device is described as having a feature X, the device may have one or more of feature X.

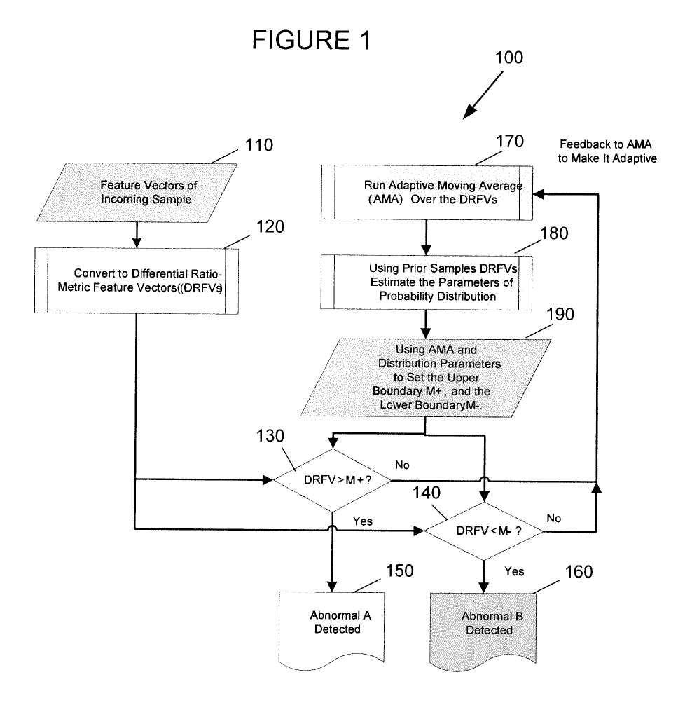

An Adaptive Orthogonal Ratio-Metric Detector (AORD) according to the first embodiment is an apparatus or method that uses differential sensors or sensing technologies and applies adaptive ratio-metric algorithm to detect abnormalities as well as to identify target chemicals. The flowchart of the AORD according to the first embodiment is depicted in FIG. 1.

The sensory component of the AORD device according to the first embodiment is constructed by choosing sensors or sensing technologies based on the differential characteristics of sensor interactions to detecting analytes. For example, two sensors that have differential or orthogonal detection characteristics can be utilized in the first embodiment.

A pair or a few pairs of differential sensors include one sensor or sensors from a first category of sensors, such as a carbon nanotube sensor, and another sensor or sensors from a second category of sensors, such as a polymer composite sensor.

The definition of two differential sensors is such that two sensors have their different preferences to respond to chemical-A (class-A) and they may also show opposite preferences to respond to chemical-B (class-B) provided that chemical-A and chemical-B are in different chemical categories. Two orthogonal sensors have completely different responses to the two different chemicals (e.g., sensor #1 has a high response to chemical A, no response to chemical B, and sensor #2 has a high response to chemical B, and no response to chemical A).

The AORD according to the first embodiment extracts feature vectors from raw data, which is similar to conventional pattern recognition algorithms. For example, the feature vectors can be sensor responses. However, the AORD according to the first embodiment does not use multivariate analysis, such as normalization, autoscale, pattern recognition, etc. Instead, it applies ratio-metrics to the feature vectors from a few pairs of differential (e.g., orthogonal) sensors to create differential-ratio-metric feature vectors (DRFVs). The differential-ratio-metric data processing eliminates most of the concentration effects of chemical analytes. Therefore, it enlarges the distances among the classes but reduces the distances within the classes, which makes identification of particular chemicals in a sample more robust. For example, in testing recycled water bottles for impurities such as a trace of gasoline and/or ammonia, the AORD according the first embodiment will reduce the concentration effects of water in the water bottles, so that impurities in dry and relative dry water bottles will be detected in a same manner as impurities in wet and relatively-wet water bottles.

The AORD according to the first embodiment also uses an adaptive-moving-average algorithm so that the changes of its parameters are made adaptively when the samples are detected as in normal status. In contrast, no changes of its parameters are made when the samples are detected as abnormalities. Comparing with a multivariate analysis algorithm, the AORD according to the first embodiment works more robustly than conventional multivariate pattern recognition techniques when the environment changes (e.g., due to temperature and/or pressure and/or humidity changes).

The first embodiments operates under the principle that an incoming DRFV of a ‘normal’ sample distributes close to its moving average and follows its probability distribution. In one possible implementation of the AORD according to the first embodiment, the distribution parameters are calculated by applying a chi-square computation on prior DRFV data within a certain period of time (e.g., for the last X samples obtained over the past 100 seconds). Having the distribution parameters and the confidence level, an upper and a lower boundary can then be set.

In the AORD according to the first embodiment, when an incoming sample's DRFV falls outside of the upper and lower boundaries, the sample will be considered as an “abnormal” sample, whereby abnormal sample can then be reported and recorded.

In addition, using the criterion that either the DRFV is greater than the upper boundary or less than the lower boundary, the chemical characteristics of the abnormal sample can be determined (e.g., abnormal due to a trace of ammonia detected within sample, or abnormal due to a trace of hydrocarbons detected within sample).

The AORD system according to the first embodiment utilizes one or more pairs of differential sensors, such as one or more pairs of orthogonal sensors or substantially orthogonal sensors. In one possible implementation of the first embodiment, a pair of differential sensors that are used include a first sensor that corresponds to a nanotube sensor with a sulfonic group, which is useful for detecting very low concentrations of ammonia, and a second sensor that corresponds to a polymer composite sensor (e.g., conduct-x composite sensor) that is useful for detecting very low concentrations of hydrocarbons. Ideally, the two sensors making up the differential sensor pair are orthogonal to each other in that the first sensor is very sensitive to a first analyte (e.g., ammonia and water vapor) and not at all sensitive to a second analyte (e.g., hydrocarbons), while the second sensor is very sensitive to the second analyte and not at all sensitive to the first analyte. A multiple-pair sensor system (e.g., two or more differential sensor pairs) has the advantage of functional backup, in that if one sensor pair malfunctions, another sensor pair can be used in its place (or to provide agreement or disagreement with the results provided by the first sensor pair). Data fusion software and/or a simple logic can be utilized to handle multiple detection outputs (e.g., OR-gate logic), so that only one outcome will be declared for each sample.

The AORD according to the first embodiment departs from devices that use conventional multivariate analysis systems in that the AORD need not be trained, which results in significant cost reduction of time and labor.

FIG. 1 is a flow diagram showing the steps involved in a detection and classification process according to a first embodiment of the invention. In a step 110, feature vectors of an incoming sample are obtained. This step involves the application of a sample to at least one pair of differential sensors (e.g., to detect a vapor emanating from the sample, or to be put in direct contact with the sample), and the computation of feature vectors. Feature vectors are computed in a manner known to those of ordinary skill in the art. For example, a 10 point difference feature vector can be obtained.

In a step 120, the feature vectors obtained in step 110 are converted to a differential ratio-metric feature vectors (DRFV). For example, a ratio-metric feature vector corresponds to the feature vector obtained from the first sensor of the sensor pair divided by the feature vector obtained from the second sensor of the sensor pair (e.g., FV1/FV2). A DRFV is obtained for each of the sensors in the array of sensors (e.g., two DRFVs are usually obtained for a sensor array that corresponds to two pairs of orthogonal sensors).

In a third step 130, the DRFVs are compared to an upper threshold, M+, and in a fourth step 140 performed simultaneously with the third step 130, the DRFVs are compared to a lower threshold, M. If at least one of the DRFVs is greater than M+, then a first abnormality is detected in a step 150, and if at least one of the DRFVs is less than M−, then a second abnormality is detected in a step 160. For example, the first abnormality may correspond to ammonia (NH3) being detected in the sample over a first prescribed lower limit, and the second abnormality may correspond to a particular hydrocarbon (e.g., kerosene, gasoline) being detected in the sample over a second prescribed lower limit.

By way of example, if the samples correspond to water bottles that have been returned to a drinking water process plant, each water bottle is subjected to testing by way of the AORD according to the first embodiment, and then washed out, cleaned and refilled with drinking water for sale if the bottle has not been rejected. Prior to such testing of water bottles, a number (e.g., 10) of ‘clean’ water bottles are tested to obtain default “normal” DRFVs to be used to set the M− and M+values, in a calibration process. Once those values have been obtained, recycled water bottles to be categorized as normal or abnormal are then subjected to the AORD according to the first embodiment, whereby a bottle is considered abnormal, and thus rejected (or considered inappropriate for use as a recycled drinking bottle anymore), if either it contains a trace of ammonia or a trace of hydrocarbons. A normal bottle is considered to be appropriate for subsequent cleaning and refilling to thereby create new bottle of drinking water.

If a bottle that has been tested and is considered “normal”, e.g., its DRFVs are between the range of M− and M+, then the DRFVs of that bottle are used in a feedback path, in order to make the system and method adaptive to changing environmental conditions that may occur during the time period from the start of the testing to the end of the testing (whereby that testing may be performed over several hours or over several days). The DRFVs of each bottle that has been tested as “normal” are fed to a “Run Adaptive Moving Average (AMA) Over the DRFVs” step 170. For example, in a first possible implementation, the AMA can be set to compute an average for the most recent X DRFVs, as a sliding window approach, whereby X is a positive integer (e.g., 10, 20, etc.), and whereby all non-recent DRFVs are excluded from the computation of the AMA. In a second possible implementation, the AMA can be set to compute an average from all previous DRFVs, whereby a weighting scale is provided to weigh more heavily toward the most recently received DRFVs (e.g., linear weight scale or exponential weight scale). In a third possible implementation, both a weight scale approach (second implementation of AMA)) and a sliding window approach (first implementation of AMA) are utilized together to provide for an updated computation of M− and M+.

In a step 180, which is provided with the results of the step 170, prior samples of DRFVs are used to estimate the parameters of probability distribution, whereby those parameters correspond to the mean “□” and the standard deviation “δ”. In a step 190, the AMA results obtained from the step 170 and the probability distribution parameters obtained from the step 180 are used to modify the upper and lower boundaries and M+ and M−. The modified upper and lower boundaries M+ and M− are used in the steps 130 and 140 to detect whether a next bottle to be sampled is normal or abnormal.

As one example, consider a case whereby a test is started in the morning, when the humidity is high in a testing environment. In the first embodiment, the M+ and M− values are computed during a calibration phase that is performed just before the actual testing of samples (e.g., water bottles) is to be performed, and thus the calibration phase is also performed during a high humidity environment in this example. Accordingly, the M+ and M− values are set based on the environmental conditions, to accurately detect whether a sample is normal or abnormal. Now, during the testing of samples, say after a few hours, the environment becomes less humid. By way of the first embodiment, which performs adaptive feedback by computing a running adaptive moving average, the environmental condition changes are reflected in the testing by recomputing the M+ and M− values accordingly. That way, by way of the first embodiment, accurate testing of samples, such as recycled water bottles, can be made over a long period of time in which the environmental conditions change.

In one recent test performed by the inventor, two prototype AORD devices were built and tested successfully in-house on a 5-gallon water bottle. In this test, 10 mL of 1.0% sodium hydroxide (NaOH), 10 mL of 1.15 g/L Ammonium Chloride (NH₄Cl), and 80 mL of distilled water were added to the 5-gallon water bottle, whereby the water bottle was then capped and let stand for 30 minutes. Each of the two testing devices used two pairs of orthogonal sensors, one being a composite polymer sensor and the other being a carbon nanotube sensor. The results of such testing resulted in an expansion of detection capacity to very low concentration of ammonia gas as well as hydrocarbon vapors, whereby the detection limit of ammonia gas concentration down to 30 ppm (parts per million) or less was achieved. Based on these tests, the first embodiment results in simplicity of operation, robust performance and good adaptation to environmental changes.

Other possible applications for the present invention include: a) food spoilage detection, and b) air sensor detection for indoors and outdoors. For example, to detect whether or not meat or fish has become spoiled, conventional testing methods involve human visual and/or smell detection. By way of the first embodiment, however, a differential sensor pair whereby one sensor in the sensor pair is highly sensitive to food spoilage, such as amine detection to detect fish spoilage, and the other sensor in the sensor pair is not at all sensitive to amine detection, can be used to check fish products to determine which ones should be thrown out due to too much spoilage, and which ones are acceptable for consumption (and thus allowed to be sold at a market or grocery store).

In an alternative implementation of the first embodiment, it can be used as an air sensor to detect whether or not the air in a region (e.g., within a building or at an outside area) is acceptable or not or whether a trace of toxic industrial chemicals (TIC) exists. For example, the use of a pair of differential sensors in which one sensor is highly sensitive to carbon monoxide and the other sensor in the pair is not at all sensitive to carbon monoxide, can be used to detect whether or not the air in a building is safe or not, whereby a large diesel truck idling outside an intake air vent may result in an abnormal detection to be made, and an alarm to be output to warn persons in the building to get out.

The use of ratio-metric feature vectors enlarges the distance among different classes to be detected, while at the same time reducing the distances within each of the different classes (e.g., different chemical groups). As a result, the present invention allows for differential detection to be performed to detect very small quantities of an analyte, such as ammonia in a concentration of lower than 30 ppm, using at least one differential or orthogonal pair of sensors. Also, normalization is not performed on the sensor data in the first embodiment. In the case of that a feature vector of one of the sensors is overwhelmingly stronger than those of other sensors, normalization used for multivariate analysis would reduce the feature differences between the two different classes of analytes to be detected. Therefore, applying normalization would be counterproductive in those cases.

In the first embodiment, no matter the condition of the sample to be tested, for example, a wet recycled water bottle or a dry recycled water bottle, applying ratio-metrics to the feature vectors, in order to obtain DRFVs, reduces the concentration effect of same chemicals. This allows for low-level detection of abnormalities in a plurality of samples to be checked, in which those plural samples may have different characteristics with respect to each other (e.g., some are entirely wet and some are entirely dry, and some are in between).

In one possible implementation of the first embodiment, M+ is set to the computed mean value (as obtained from the computations performed in the step 170 shown in FIG. 1) PLUS three times the standard deviation (as obtained from the computations performed in the step 170 shown in FIG. 1), and M− is set to the computed mean value (as obtained from the computations performed in the step 170 shown in FIG. 1) MINUS three times the standard deviation (as obtained from the computations performed in the step 170 shown in FIG. 1), That way, a three-sigma (3δ) normal detection scheme is set up, whereby abnormalities that are outside the three-sigma range are considered abnormal and all other samples are considered to be normal. Of course, one skilled in the art will recognize that the setting of the M− and M+values can be modified to suit a particular purpose (e.g., M+=mean+1 standard deviation, and M−=mean−1 standard deviation), and still be within the spirit and scope of the invention.

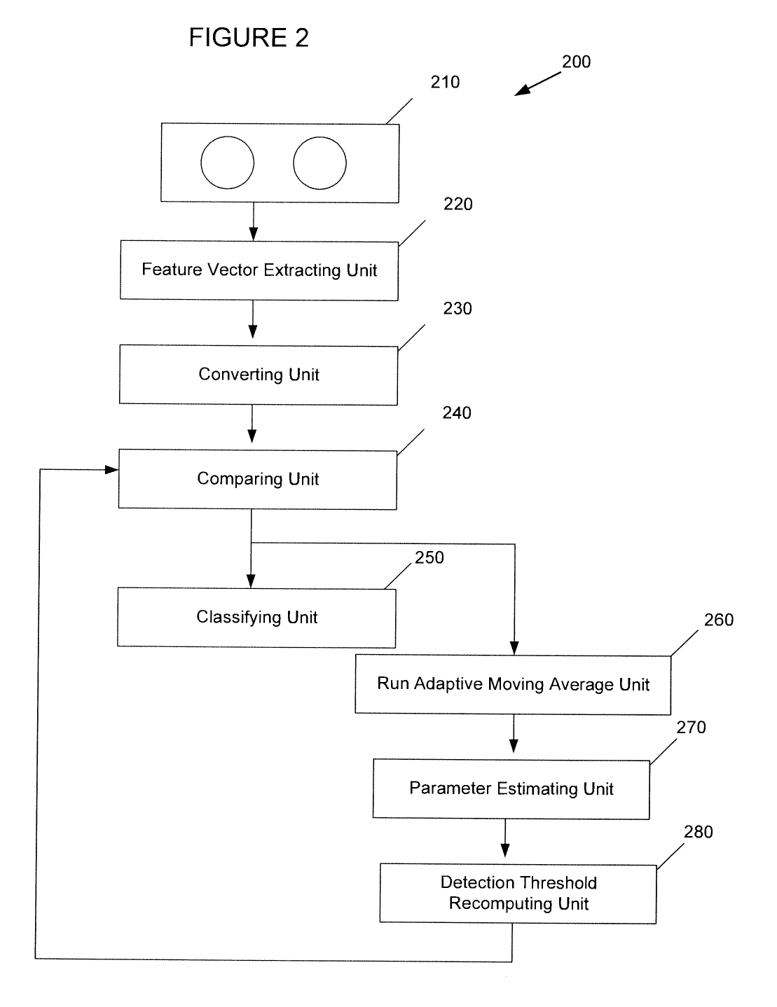

An AORD system 200 according to a second embodiment is shown in FIG. 2, and includes an array of sensors 210 that includes at least two differential sensors that are provided on or near a sample to be analyzed. The system further includes a feature vector extracting unit 220 configured to obtain at least one feature vector from the sample to be analyzed. The system 200 also includes a converting unit 230 configured to convert the at least one feature vector to at least one ratio-metric feature vector. The system 200 further includes a comparing unit 240 configured to compare the at least one ratio-metric feature vector to a detection threshold, and to output an alarm to denote that the sample is abnormal when the detection threshold is exceeded. The system 200 still further includes a classifying unit 250 configured to classify the sample as normal when the detection threshold is not exceeded, a run adaptive moving average unit 260 configured to compute a run adaptive moving average using the at least one feature vector and prior feature vectors obtained from normal samples, a parameter estimating unit 270 configured to estimate parameters of probability distribution using the prior feature vectors obtained from normal samples, and a detection threshold recomputing unit 280 configured to recompute the detection threshold based on the parameters of probability distribution, to be used to detect a future sample to be analyzed.

In a third embodiment, which is a computer implementation of the method according to the first or second embodiments, one or more of the steps and/or the components described above with respect to the first and second embodiments may be embodied in software. That software is stored as a computer program on a computer readable medium (e.g., a hard disk drive or a compact disk), whereby the third embodiment is executable on a computer or a microprocessor that executes the program.

The embodiments described above have been set forth herein for the purpose of illustration. This description, however, should not be deemed to be a limitation on the scope of the invention. Various modifications, adaptations, and alternatives may occur to one skilled in the art without departing from the claimed inventive concept. For example, the types of differential sensors that can be utilized in the present invention include ion-mobility spectrometry (IMS) sensors, metal-oxide semiconductor (MOS) sensors, and photoionization detector (PID) sensors. Other uses of the present invention include homeland security applications (e.g., bomb detection), toxic industrial chemical (TIC) detection, and breath analysis (e.g., for use by police to test a vehicle driver suspected of being intoxicated). Also, the feedback of DRFVs can also be used to deal with drift in sensor characteristics over time, so that a sample determined as being “normal” at a beginning stage of a test will not be determined to be “abnormal” at a later stage of a test, due to drift in sensor characteristics, because the drift will be accounted for in the recomputation of the “normal upper” and “normal lower” boundaries M±, M. The spirit and scope of the invention are indicated by the following claims.

1. A method for detecting and classifying sensor data, comprising:
a) obtaining at least one feature vector from a sample to be analyzed, the sample to be analyzed being applied to an array of sensors that includes at least two differential sensors;
b) converting the at least one feature vector to at least one ratio-metric feature vector;
c) comparing the at least one ratio-metric feature vector to a detection threshold, and outputting an alarm to denote that the sample is abnormal when the detection threshold is exceeded; and
d) when the at least one ratio-metric feature vector does not exceed the detection threshold,
d1) classifying the sample as normal,
d2) performing a run adaptive moving average using the at least one feature vector and prior feature vectors obtained from normal samples,
d3) estimating parameters of probability distribution using the prior feature vectors obtained from normal samples, and
d4) recomputing the detection threshold based on the parameters of probability distribution, to be used to detect a future sample to be analyzed.

2. The method according to claim 1, wherein the at least two differential sensors are orthogonal sensors with respect to detection of at least one analyte.

3. The method according to claim 1, wherein the at least two differential sensors includes a first sensor that corresponds to a carbon nanotube sensor and a second sensor that corresponds to polymer composite sensor.

4. The method according to claim 1, wherein the detection threshold includes a first detection threshold and a second detection threshold larger than the first detection threshold, and wherein the step c) comprises:
c1) outputting a first alarm to denote that the sample is abnormal due to a trace amount of a first analyte in the sample when the at least one ratio-metric feature vector exceeds the second threshold; and
c2) outputting a second alarm to denote that the sample is abnormal due to a trace amount of a second analyte in the sample when the at least one ratio-metric feature vector is less than the first threshold.

5. The method according to claim 4, wherein the at least two differential sensors includes a first sensor that corresponds to a carbon nanotube sensor and a second sensor that corresponds to polymer composite sensor.

6. The method according to claim 5, wherein the first analyte is ammonia, and wherein the second analyte is hydrocarbon.

7. A method for detecting and classifying sensor data, comprising:
a) obtaining at least one feature vector from a sample to be analyzed, the sample to be analyzed being applied to an array of sensors that includes at least two differential sensors;
b) converting the at least one feature vector to at least one ratio-metric feature vector;
c) comparing the at least one ratio-metric feature vector to a detection threshold, and outputting an alarm to denote that the sample is abnormal when the detection threshold is exceeded; and
d) when the at least one ratio-metric feature vector does not exceed the detection threshold, classifying the sample as normal and feeding back the at least one ratio-metric feature vector to recompute the detection threshold for future samples to be detected and classified.

8. The method according to claim 7, wherein the step d) further comprises:
d1) performing a run adaptive moving average using the at least one feature vector and prior feature vectors obtained from normal samples,
d2) estimating parameters of probability distribution using the prior feature vectors obtained from normal samples, and
d3) recomputing the detection threshold based on the parameters of probability distribution, to be used to detect and classify the future samples.

9. The method according to claim 8, wherein the at least two differential sensors are orthogonal sensors with respect to detection of at least one analyte.

10. The method according to claim 9, wherein the at least two differential sensors includes a first sensor that corresponds to a carbon nanotube sensor and a second sensor that corresponds to a polymer composite sensor.

11. The method according to claim 7, wherein the detection threshold includes a first detection threshold and a second detection threshold larger than the first detection threshold, and wherein the step c) comprises:
c1) outputting a first alarm to denote that the sample is abnormal due to a trace amount of a first analyte in the sample when the at least one ratio-metric feature vector exceeds the second threshold; and
c2) outputting a second alarm to denote that the sample is abnormal due to a trace amount of a second analyte in the sample when the at least one ratio-metric feature vector is less than the first threshold.

12. The method according to claim 11, wherein the at least two differential sensors includes a first sensor that corresponds to a carbon nanotube sensor and a second sensor that corresponds to a polymer composite sensor.

13. The method according to claim 12, wherein the first analyte is ammonia, and wherein the second analyte is hydrocarbon.

14. A system for detecting and classifying sensor data, comprising:
an array of sensors that includes at least two differential sensors that are provided on or near a sample to be analyzed;
a feature vector extracting unit configured to extract at least one feature vector from the sample to be analyzed;
a converting unit configured to convert the at least one feature vector to at least one ratio-metric feature vector;
a comparing unit configured to compare the at least one ratio-metric feature vector to a detection threshold, and to output an alarm to denote that the sample is abnormal when the detection threshold is exceeded;
a classifying unit configured to classify the sample as normal when the detection threshold is not exceeded;
a run adaptive moving average unit configured to compute a run adaptive moving average using the at least one feature vector and prior feature vectors obtained from normal samples;
a parameter estimating unit configured to estimate parameters of probability distribution using the prior feature vectors obtained from normal samples; and
a detection threshold recomputing unit configured to recompute the detection threshold based on the parameters of probability distribution, to be used to detect a future sample to be analyzed.

15. The system according to claim 14, wherein the at least two differential sensors are orthogonal sensors with respect to detection of at least one analyte.

16. The system according to claim 14, wherein the at least two differential sensors includes a first sensor that corresponds to a carbon nanotube sensor and a second sensor that corresponds to a polymer composite sensor.

17. A system for detecting and classifying sensor data, comprising:
a feature vector extracting unit configured to extract at least one feature vector from a sample to be analyzed, the sample to be analyzed being applied to an array of sensors that includes at least two differential sensors;
a converting unit configured to convert the at least one feature vector to at least one ratio-metric feature vector;
a comparing unit configured to compare the at least one ratio-metric feature vector to a detection threshold, and outputting an alarm to denote that the sample is abnormal when the detection threshold is exceeded; and
a classifying unit configured to classify the sample as normal when the at least one ratio-metric feature vector does not exceed the detection threshold,
wherein the at least one ratio-metric feature vector is fed back in a feedback loop to recompute the detection threshold for future samples to be detected and classified.

18. The system according to claim 17, wherein the feedback loop comprises:
a run adaptive moving average computation unit configured to compute a run adaptive moving average of the at least one ratio-metric feature vector and previously-received ratio-metric feature vectors performed during a single test run; and
a probability distribution parameter estimation unit configured to estimate probability distribution parameters based on the previously-received ratio-metric feature vectors performed during a single test run and the at least one ratio-metric feature vector,
wherein the estimated probability distribution parameters are used to set the detection threshold for the future samples to be detected and classified.

19. A computer readable medium storing a computer program, which, when executed on a computer or a microprocessor, is used to detect and classify sensor data, the computer program when executed on the computer or the microprocessor performing the steps of:
a) obtaining at least one feature vector from a sample to be analyzed, the sample to be analyzed being applied to an array of sensors that includes at least two differential sensors;
b) converting the at least one feature vector to at least one ratio-metric feature vector;
c) comparing the at least one ratio-metric feature vector to a detection threshold, and outputting an alarm to denote that the sample is abnormal when the detection threshold is exceeded; and
d) when the at least one ratio-metric feature vector does not exceed the detection threshold, classifying the sample as normal and feeding back the at least one ratio-metric feature vector to recompute the detection threshold for future samples to be detected and classified.

20. The computer readable medium according to claim 19, wherein the at least two differential sensors are orthogonal sensors with respect to detection of at least one analyte.
